(19) United States
(12) Patent Application Publication
(10) Pub. No.: US 2010/0076648 A1
(43) Pub. Date: Mar. 25, 2010

(54) TRUCK AND BODYBUILDER MODULE FOR THIS TRUCK, METHOD, MEMORY AND SOFTWARE TO CONFIGURE THE BODYBUILDER MODULE

(75) Inventors: Franck Paul Germain Molina, Dompierre Sur Vey (FR); Roger Schmidt, Villeurbanne (FR)

Correspondence Address: WRB-IP LLP, 1217 KING STREET, ALEXANDRIA, VA, 22314, US

(73) Assignee: RENAULT TRUCKS, Saint Priest (FR)

(21) Appl. No.: 12/513,511

(22) PCT Filed: Nov. 21, 2006
(86) PCT No.: PCT/IB2006/004066

§ 371 Date: May 5, 2009

(51) Int. Cl. G06F 7/00; G05B 19/042

(52) U.S. Cl. 701/36; 700/87

(57) ABSTRACT

A truck and a bodybuilder module for a truck, a method, a memory and software to configure the bodybuilder module are provided. The truck includes a first non-volatile memory zone, content of which cannot be modified, the first non-volatile memory zone storing authorized mathematical operators and a plurality of authorized operands, each operand corresponding to a data generated by one of the electronic control units or one of the sensors, a second non-volatile memory zone, content of which can be modified, the second non-volatile memory zone storing information defining a mathematical operation, the mathematical operation being formed by a combination of operators and operands, a microprocessor able to execute the mathematical operation defined by the information stored in the second non-volatile memory zone only if each of the operators and operands of the defined mathematical operation matches an authorized operator or operand stored in the first non-volatile memory zone, and to transmit the result of the executed mathematical operation to the auxiliary unit through the auxiliary unit connection.

### BACKGROUND AND SUMMARY

The present invention relates to a truck and a bodybuilder electronic module for this truck, a method, a memory and a software to configure the bodybuilder electronic module.

Typically, a truck includes:
a plurality of electronic control units able to control actuators of the truck and/or sensors, the control unit and the sensors being able to generate respective data that represent the operative state of the truck,
a bus linking together the electronic control units and the sensors,
a bodybuilder electronic module connected to the bus, the electronic module comprising an auxiliary unit connection to connect an auxiliary unit chosen amongst a plurality of different auxiliary units which can be installed on this truck, each auxiliary unit being able to drive an auxiliary equipment added to the truck after its construction, this connection being able to transmit, to the auxiliary unit, information on the operating state of the truck which is built from data read on the bus, and
a configuration connection to connect and, alternatively, to disconnect a configuration computer to the bodybuilder electronic module,

Bodybuilders are companies that install auxiliary units on the trucks. The auxiliary units drive auxiliary equipments like a movable container, a pump, a tank, a rubbish compactor and so on.

For example, the auxiliary units comprise a motor that drive a shaft, a valve, a cylinder or other actuators of the auxiliary equipment.

The auxiliary units need to be triggered or stopped depending on the state of operation of the truck. For example, the auxiliary units have to lift a container only if the park brake is on.

Thus, auxiliary units need to retrieve data from the bus of the truck. EP 1 196 370 discloses a bodybuilder electronic module which is called a remote interface module. This module includes a plug to connect the auxiliary unit. It is also possible to configure which output pin of the plug will be used and which vehicle data will be outputted through it. To this end, specific functions and tables are implemented within an ECS (Electrical System Controller) of the truck. The ECS is connected to the remote interface module through the bus. Harmful modifications can be done because the specific functions and tables are directly implemented within the ECS. Accordingly, configuration of the remote interface module can only be done during the truck manufacturing process by specialized persons.

Accordingly, it is desirable to provide a truck with a bodybuilder electronic module that can be used by bodybuilders while preserving a high level of flexibility.

The invention provides, according to an aspect thereof, a truck having a bodybuilder electronic moduli comprising:
a first non-volatile memory zone, content of which cannot be modified through the configuration connection, the first non-volatile memory zone storing a first predetermined list of authorized mathematical operators and a second predetermined list of a plurality of authorized operands, each operand corresponding to a data generated by one of the electronic control units or one of the sensors,
a second non-volatile memory zone, content of which can be modified through the configuration connection, the second non-volatile memory zone storing information defining a mathematical operation, the mathematical operation being formed by a combination of operators and operands,—a microprocessor able:
to execute the mathematical operation defined by the information stored in the second non-volatile memory zone only if each of the operators and operands of the defined mathematical operation matches an authorized operator or operand stored in the first non-volatile memory zone, and—to transmit the result of the executed mathematical operation to the auxiliary unit through the auxiliary unit connection.

The above bodybuilder electronic module has the ability to satisfy the need of very different bodybuilders because the information retrieved from the auxiliary unit connection can be a combination of a plurality of data transmitted on the truck bus. Thus, the above bodybuilder electronic module is very flexible.

When using the above bodybuilder electronic module it is only possible to implement an operation which is harmless for the truck. This is due to the fact that only a predetermined set of mathematical operators and operands can be executed.

Thus, the bodybuilder electronic module configuration can be done by the bodybuilder without any risk of causing any damage to the truck.

The embodiments of the above truck may comprise the following features:
the bus is a CAN (Control Area Network) bus. The invention also relates to a bodybuilder electronic module suitable to be implemented within the above truck.

The embodiments of the above bodybuilder electronic module may comprise one or several of the following features:
an interface to directly connect the electronic module to the truck bus, this interface being only able to read data on the bus without being able to transmit data on this bus,
the first list is only composed of Boolean operators and threshold comparators,
the module also comprises a configuration connection to connect and, alternatively, to disconnect the configuration computer to the bodybuilder electronic module,
the module also comprises a plug to connect and, alternatively, to disconnect the module to/from the truck bus,
the auxiliary unit connection is also able to receive data from the auxiliary unit, and the second predetermined list of operands also includes an operand corresponding to the data received through the input pin,
the second non-volatile memory zone stores information defining a threshold, and the microprocessor is able to compare data read on the bus to the defined threshold, and—at least one configurable delay line able to delay the data read on the bus or on the input pin by a configurable time delay, and the second non-volatile memory zone includes information defining the time delay used in the configuration line.

The above embodiments of the bodybuilder electronic module present the following advantages:
using an interface which is only able to read data on the bus increases the security because the electronic module cannot be used to alter the truck data. Furthermore, the electronic module can be implemented in a truck without requiring any configuration or modification of the truck;
using only Boolean operators or comparators make the electronic module easier to program;
including the configuration plug within the electronic module makes this electronic module safer because it does not need to use any other equipment embedded within the truck like for example the bus;
providing the electronic module with a connector to connect it to the bus makes the installation of this electronic module easier;
providing the electronic module with an auxiliary unit connection able to receive data from the auxiliary unit increases the flexibility of the electronic module; and
providing the electronic module with delay lines and threshold further increases the flexibility of this electronic module.

The invention also relates to a method to configure the above bodybuilder electronic module, the method comprising:
providing the above bodybuilder electronic module,
displaying mathematical operators and operands in respective list zones, each list zone being populated only with the authorized mathematical operators and operands, respectively,
acquiring the operator and operand selected by an operator in the list zone to define a mathematical operation, and
downloading the defined mathematical operation into the second nonvolatile memory zone from a computer connected to the electronic module through the configuration plug.

The invention also relates to a memory and a software including instructions to execute the above method to configure the bodybuilder electronic module when those instructions are executed by a computer.

These and other aspects of the invention will be apparent from the following description, drawings.

### BRIEF DESCRIPTION OF THE DRAWINGS

FIG. 1 is a schematic diagram of a vehicle equipped with a bodybuilder electronic module;

FIG. 2 is a more detailed view of the bodybuilder electronic module used in the vehicle of FIG. 1;

FIG. 3 is a schematic diagram of a display of a software used to configure the bodybuilder electronic module of FIG. 2; and

FIG. 4 is a flowchart of a method to configure the bodybuilder electronic module of FIG. 2. In the drawings, the same reference numbers are used to designate the same elements.

### DETAILED DESCRIPTION

In the following description, well-known functional constructions by a person of ordinary skill in the art are not described in details.

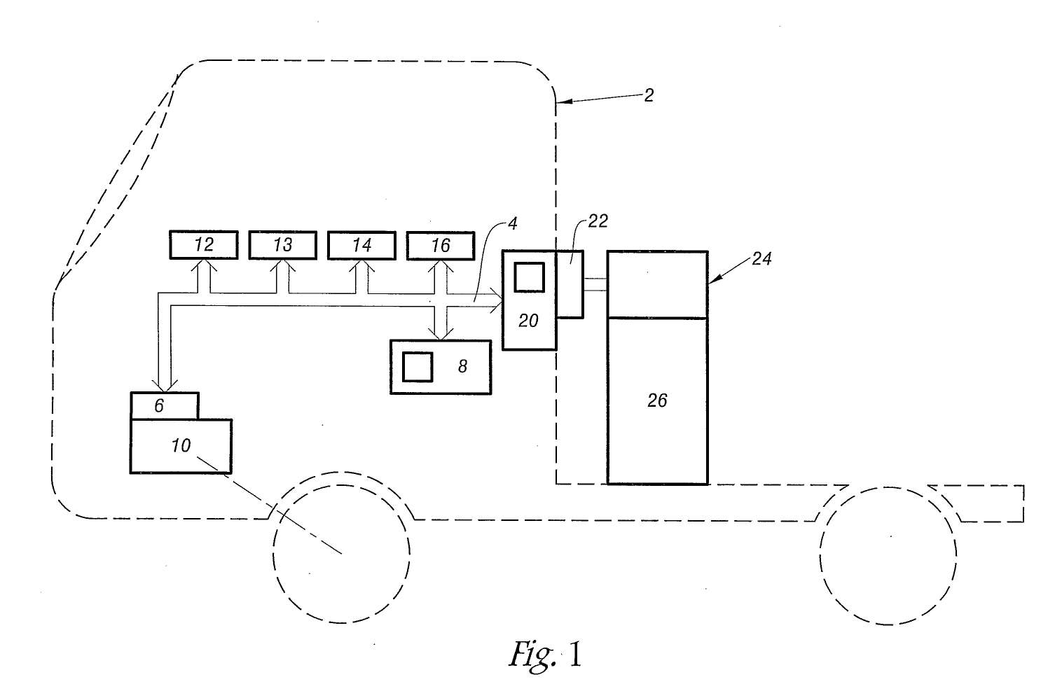

FIG. 1 shows an automotive vehicle. More precisely, FIG. 1 shows a truck 2.

Truck 2 includes many ECU (Electronic Control Units) and sensors which are connected to each other through a serial data bus 4. For example, bus 4 is a multicast bus like a CAN (Controller Area Network) bus. ECUs are embedded systems that control one or more of the electrical subsystems of the truck. Some trucks may have up to thirty ECUs. For example, truck 2 includes the following ECU:
engine control unit,
transmission control unit (TCU),—man machine interface (MMI),
door control unit,
seat control unit,
climate control unit,
anti-lock braking system (ABS) unit or Electronic Braking System (EBS) unit.

For simplicity, only engine control unit 6 and EBS unit 8 have been illustrated in FIG. 1.

Unit 6 controls an engine 10 that drives truck wheels.

Unit 6 is able to generate and transmit data on bus 4. For example, engine 6 transmits data like engine speed and engine torque.

For simplicity, only the following sensors are represented in FIG. 1 as being connected to bus 4:
a sensor 12 that outputs the park brake state on bus 4,
a sensor 13 that outputs the vehicle speed on bus 4,
a sensor 14 that transmits the clutch state on bus 4,
a sensor 16 that transmits Boolean data indicating that the transmission is in the neutral state or not. A bodybuilder electronic module 20 is also directly connected to bus 4.

Electronic module 20 is also connected by a plug 22 to an auxiliary unit 24. Auxiliary unit 24 is permanently mounted on truck 2. For example, auxiliary unit 24 is an electrical motor, a thermal motor or a pump that is used to drive auxiliary equipment 26. Auxiliary equipment 26 is permanently mounted in vehicle 2. For example, equipment 26 is a tank, a movable container, a valve, a hydraulic/automatic cylinder, a compactor.

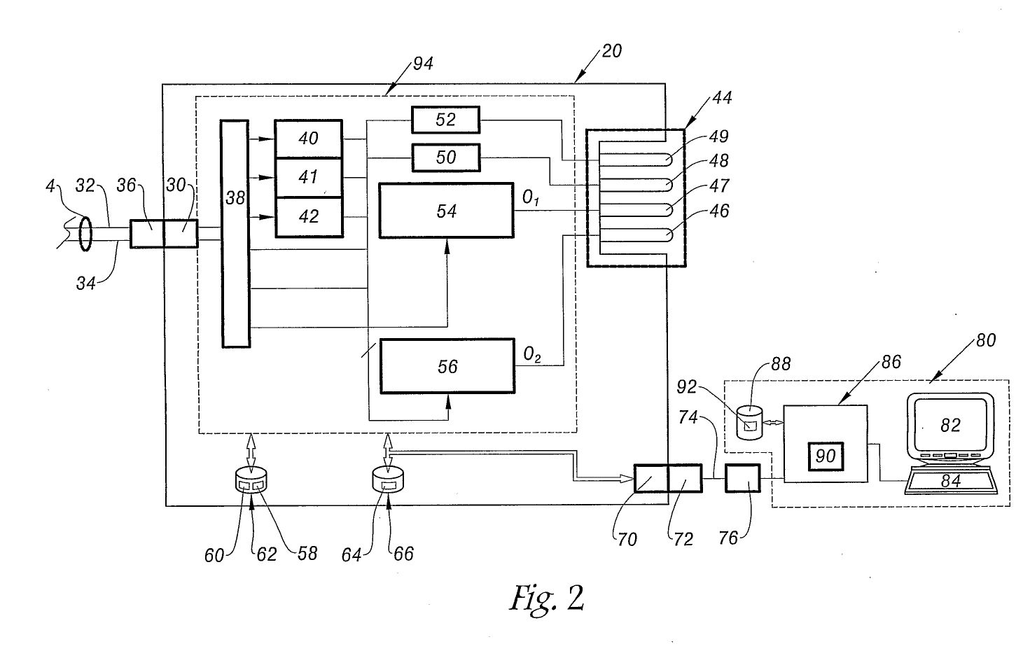

FIG. 2 shows in more details bodybuilder electronic module 20. Electronic module 20 has a plug 30 to connect electronic module 20 to bus 4 and, alternately, to disconnect electronic module 20 from bus 4. Thus, module 20 takes the form of a removable box that includes every electronic components necessary to interface auxiliary unit 24 to bus 4.

As shown in FIG. 2, bus 4 includes two wires 32 and 34 to transmit data. Preferably, wires 32 and 34 are twisted wires. Bus 4 has a corresponding plug 36 intended to fit into plug 30.

Plug 30 is directly connected through two wires to an interface 38 which is only able to read data on bus 4. For example, interface 38 is able to read the following data:
engine speed,—vehicle speed,
engine torque,
neutral state,
clutch state,
park brake state.

The engine speed, vehicle speed and engine torque are numerical values. The neutral state, clutch state and park brake state are Boolean values.

In this embodiment, the numerical values are sent to respective comparators

40-42. Each comparator 40-42 compares the numerical values to a respective threshold S; which can be configured. The output of comparator 40-42 is a Boolean value equal to “1” if the numerical value is superior to threshold Sj and, otherwise, equal to “0”.

Electronic module 20 has a connection to transmit data and receive data from auxiliary unit 24. Here, this connection is a plug 44 designed to fit into plug 22 to electrically connect auxiliary unit 24 to electronic module 20. In this example, plug 44 has four pins 46 to 49. Pins 46 and 47 are output pins that output information from truck 2 to auxiliary unit 24. Pins 48 and 49 are input pins that receive information from auxiliary unit 24. Pins 48 and 49 are directly connected through respective delay lines 50 and 52 to respective inputs of calculators 54 and 56. Outputs of comparator 40 to 42 as well as the Boolean value received through interface 38 are also connected to respective inputs of calculators 54 and 56.

Each calculator 54 and 56 is able to execute a mathematical operation which involves data read on bus 4 and data received through input pins 48 and 49. The data that can be used as operand in the mathematical operation are defined in a list 58. The mathematical operators that can be used in this mathematical operation are defined in a list 60. Lists 58 and 60 are stored in a non-volatile memory 62. For example, list 58 includes the following data:
engine speed,
vehicle speed,
engine torque,
neutral state,
clutch state,
park brake state,
input pins 48 and 49, and
a logical “0”.

List 60 only includes Boolean operators. For example, list 60 includes the following Boolean operators: AND, XOR, OR and NOT.

The mathematical operation executed by calculators 54 and 56 is defined in a list 64 stored in a non-volatile memory 66. List 64 specifies for each mathematical operation to be executed which data in list 58 are to be used as operand and which operator in list 60 has to be used. For example, list 64 contains references or pointers to the operators and operands of lists 58 and 60.

Accordingly, calculators 54 and 56 are only able in this embodiment to execute Boolean operations.

Each calculator 54 and 56 has a respective output Oi and O2 connected to pins 47 and 46, respectively. Electronic module 20 also includes a configuration connection to received configuration data from an internal computer. Here, this connection is a plug 70 through which is received list 64. Plug 70 can only be used to store new data in memory 66 but not in memory 62. Thus, lists 58 and 60 are not modifiable through plug 70.

Plug 70 is designed to fit into an external plug 72 which is fixed at the extremity of a wire 74 connecting an adapter 76 to electronic module 20. Adapter 76 is for example able to convert data received through a standard bus, like USB or RS232 bus into data transmitted on wire 74. This standard bus is connected to an external computer 80. Computer 80 has a screen 82, a keyboard 84, a central unit 86 and a memory 88.

Central unit 86 includes at least one microprocessor 90 able to execute instructions recorded in memory 88. A software 92 is stored in memory 88. The software 92 includes instructions to define a mathematical operation suitable to be executed by electronic module 20 and to download the defined mathematical operation as list 64 in memory 66 through adapter 76, connection 74 and plugs 72 and 70, when executed.

Interface 38, comparators 40-42, delay lines 50, 52 and calculators 54 and 56 are implemented through the use of a microprocessor 94. To this end, microprocessor 94 executes instructions recorded in memory 62, for example.

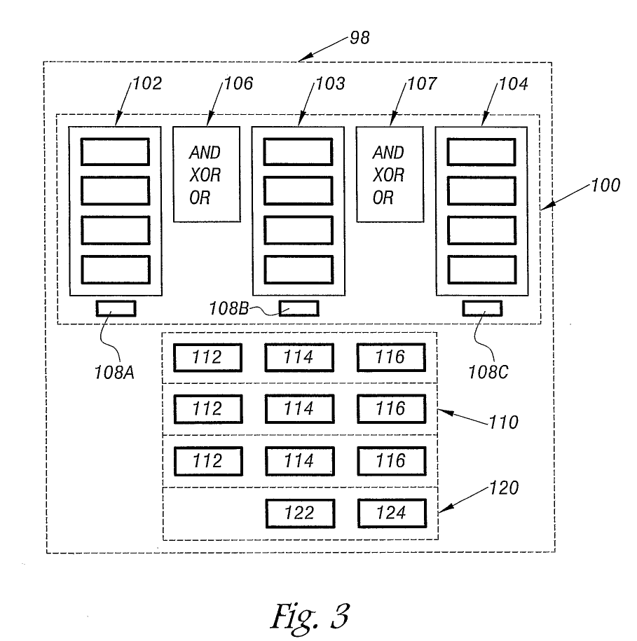

FIG. 3 shows a window 98 displayed on screen 82 when software 92 is executed by microprocessor 90. This screen includes a first area 100 to define the mathematical operation to be executed by electronic module 20. Area 100 includes three list zones 102-104. Each list zone is populated with the name of the data which can be used as operand by electronic module 20. Each name corresponds to a data stored in list 58. Each zone 102-104 allows to select at most one of these names.

Area 100 also includes two list zones 106 and 107. Zone 106 includes three names, each one corresponding to one of the operator names stored in list 60. The user can select at most one of the names in zone 106. Zone 106 defines the operators that operate on the data selected in zone 102 and 103.

For example, zone 107 is identical to zone 106. Zone 107 selects the operator that will operate on the data selected in zones 103 and 104. Area 100 also includes three buttons 108A, 108B and 108C placed under list zones 102-104, respectively. When one of these buttons 108A, 108B and 108C is selected, the operation NOT is applied to the data selected in the list zone just above.

Window 98 also includes a second area 110 used to configure the threshold Si of comparators 40-42, respectively. For example, area 110 is divided into three lines, each line corresponding to one of the comparators 40-42. A first field 112 in each line indicates the name of the data on which operates the corresponding comparator. The line also includes a second and a third field 114, 116. Field 114 is designed to receive the numerical value of the threshold Sj. Field 116 is designed to receive a numerical value that defines a hysterisis that applies on this threshold value input in field 114.

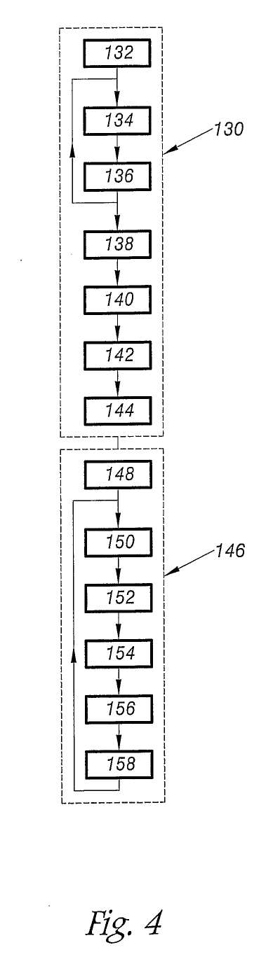

Finally, window 98 has a third area 120 that includes two fields 122 and 124 designed to receive numerical values that correspond to the time delays that delay lines 50 and 52 will implement, respectively. The operation of truck 2 and software 92 will now be described with reference to FIG. 4.

Initially, during a phase 130, an operator defines the mathematical operations to be executed by electronic module 20.

At the beginning of phase 130, in step 132, the computer 80 is connected to electronic module 20 through adapter 76, wire 74 and plugs 72-70.

Thereafter, in step 134, the operator selects in each zones 102, 103 and 104 the operands to be used in the mathematical operation. Subsequently, in step 136, the operator selects in zones 106 and 107 the operators to apply to the operands.

Step 134 and 136 can be iterated for each mathematical operation to be executed by calculators 54 and 56.

In step 138, using the field in area 110, the operator can also specifies the threshold values to be used by comparators 40-42.

In step 140, the operator enters the time delay to be implemented by delay lines 50 and 52.

Subsequently, in step 142, when the operator has finished the definition of the mathematical operation to be executed, computer 80 downloads in memory 66 a new list 64 defining the operands and the operators to be used. During step 142, the new thresholds and new delays are also stored in memory 66. Thereafter, in step 144, the operator disconnects computer 80 from electronic module 20 by unplugging plug 72.

Once electronic module 20 has been configured, in step 148, auxiliary unit 24 is connected to electronic module 20 through the use of plugs 22 and 44. Thereafter, electronic module 20 is activated to provide the required information to auxiliary unit 24.

In step 150, electronic control unit 10 and sensors 12, 14 and 16 generate and transmit data through bus 4.

In step 152, interface 38 reads the values for the data specified in list 64. Then in step 154, calculators 54 and 56 execute the mathematical operations with the newly received values. The executed mathematical operations are the ones defined in list 64.

In step 156, the results of the mathematical operations are outputted to respective pins 46 and 47.

Subsequently, auxiliary unit 24 receives these results and operates the auxiliary equipment 26 according to these new results.

Steps 150 to 158 are iterated as long as electronic module 20 is activated.

If by error or due to wrong manipulations, list 64 defines a mathematical operation that uses operands or operators that do not match the ones stored in lists 58 and 60, the mathematical operation is not executed and no result is outputted on outputs Oi or O2. Thus, steps 154 to 158 are not executed.

It should be noticed that the configuration of electronic module 20 can be replaced by a new configuration at any time by connecting once again computer 80 to electronic module 20.

Many other embodiments are possible. For example, the first and second memories 62 and 66 may correspond to separate zones of the same memory. Similarly, the auxiliary unit plug 44 and configuration plug 70 may be housed within the same connector.

In another embodiment, the configuration plug 70 is housed outside electronic module 20. For example, the configuration plug is directly connected to bus 4 and can be used to configure electronic module 20 but also other configurable truck equipments connected to bus 4.

Still in another embodiment, memories 62 and 66 are housed outside electronic module 20. For example, memories 62 and 66 are connected to electronic module 20 through bus 4.

The wired link between module 20 and the auxiliary unit 24 or between module 20 and computer 80 can be replaced by a wireless link according to a standard protocol like WiFi or Bluetooth.

Module 20 may also comprise some additional inputs to be directly connected to sensors or ECUs without passing through bus 4.

Comparators 40-42 can be omitted. If module 20 only reads Boolean data on bus 4.

Delay line 50, 52 can also be omitted. In contrast, in another embodiment, additional delay lines can be added at the output of comparators 40-42 or at the output of interface 38 to delay Boolean value. Delay lines can also be added at the outputs CM and O2.

Comparators can be added to compare data received on pins 48 or 49 to a predetermined threshold.

List 64 may also contain operands and operators. Thus, in this embodiment, the operands and operators of list 64 are compared to the ones stored in lists 58 and 60 before executing the operation defined in list 64. In case every operand and operator matches one operand or operator of lists 58 and 60, the operation stored in list 64 is executed; Otherwise, the stored operation is not executed.

### LIST OF REFERENCES

2 Truck
4 Bus
6 ECU
8 ABS
12,14,16 Sensors
20 Bodybuilder electronic module
22 Plug
24 Auxiliary unit
26 Auxiliary equipment
30,36 Plugs
32,34 Wires
38 Interface
40-42 Comparators
44 Auxiliary unit plug
46-49 Pins
50,52 Delay lines
54,56 Calculator
38,60,64 Lists
62,66 Memories
70,72 Configuration plugs
74 Connection
76 Adapter
80 Computer
82,84 Screen, Keyboard
88 Memory
86 Central unit
90 Microprocessor
92 Software
94 Microprocessor
100,110,120 Areas
102,103,104 List zones
106,107 List zones
108A, 108B, 108C Buttons
112,114,116,122,124 Fields

1. Truck comprising:
a plurality of electronic control units able to control actuators of the truck and/or sensors, the control unit and the sensors being able to generate respective data that represent the operative state of the truck,
a bus linking together the electronic control units and the sensors,
a bodybuilder electronic module connected to the bus, the electronic module comprising an auxiliary unit connection to connect an auxiliary unit chosen amongst a plurality of different auxiliary units which can be installed on this truck, each auxiliary unit being able to drive an auxiliary equipment added to the truck after its construction, this connection being able to transmit, to the auxiliary unit, information on the operating state of the truck which is built from data read on the bus, and
a configuration connection to connect and, alternatively, to disconnect a configuration computer to the bodybuilder electronic module,
a first non-volatile memory zone, content of which cannot be modified through the configuration connection, the first non-volatile memory zone storing a first predetermined list of authorized mathematical operators and a second predetermined list of a plurality of authorized operands, each operand corresponding to a data generated by one of the electronic control units or one of the sensors,
a second non-volatile memory zone, content of which can be modified through the configuration connection, the second non-volatile memory zone storing information defining a mathematical operation, the mathematical operation being formed by a combination of operators and operands,
a microprocessor able:
to execute the mathematical operation defined by the information stored in the second non-volatile memory zone only if each of the operators and operands of the defined mathematical operation matches an authorized operator or operand stored in the first non-volatile memory zone, and
to transmit the result of the executed mathematical operation to the auxiliary unit through the auxiliary unit connection.

2. The truck of claim 1, wherein the bus is a CAN (Control Area Network) bus.

3. A bodybuilder electronic module suitable to be implemented within a truck according to claim 1, wherein the module comprises:
an auxiliary unit connection to connect an auxiliary unit chosen amongst a plurality of different auxiliary units which can be installed on this truck, each auxiliary unit being able to drive an auxiliary equipment added to the truck after its construction, this auxiliary unit connection being able to transmit, to the auxiliary unit, information on the operating state of the truck which is built from data read on the bus,
a first non-volatile memory zone, content of which cannot be modified through the configuration connection, the first non-volatile memory zone storing a first predetermined list of authorized mathematical operators and a second predetermined list of a plurality of authorized operands, each operand corresponding to a data generated by one of the electronic control units or one of the sensors,
a second non-volatile memory zone, content of which can be modified through the configuration connection, the second non-volatile memory zone storing information defining a mathematical operation, the mathematical operation being formed by a combination of operators and operands,
a microprocessor able:
to execute the mathematical operation defined by the information stored in the second non-volatile memory zone only if each of the operators and operands of the defined mathematical operation matches an authorized operator or operand stored in the first non-volatile memory zone, and
to transmit the result of the executed mathematical operation to the auxiliary unit through the auxiliary unit connection.

4. The module according to claim 3, wherein the electronic module also includes an interface (38) to directly connect the electronic module to the truck bus, this interface being only able to read data on the bus without being able to transmit data on this bus.

5. The module according to claim 3, wherein the first list is only composed of Boolean operators and threshold comparators.

6. The module according to claim 3, wherein the module also comprises a configuration connection to connect and, alternatively, to disconnect the configuration computer to the bodybuilder electronic module.

7. The module according to claim 3, wherein the module also comprises a plug (30) to connect and, alternatively, to disconnect the module to/from the truck bus.

8. The module according to claim 3, wherein the auxiliary unit connection is also able to receive data from the auxiliary unit, and wherein the second predetermined list of operands also includes an operand corresponding to the data received through the input pin.

9. The module according to claim 3, wherein the second non-volatile memory zone stores information defining a threshold, and wherein the microprocessor is able to compare data read on the bus to the defined threshold.

10. The module according to claim 3, wherein the module comprises at least one configurable delay line able to delay the data read on the bus or through the auxiliary unit connection by a configurable time delay, and wherein the second non-volatile memory zone includes information defining the time delay used in the configuration line.

11. The module according to claim 3, wherein the auxiliary unit connection is a plug able to connect and, alternatively, disconnect the auxiliary unit

12. A method to configure a bodybuilder electronic module of a truck, the method comprising:
providing the bodybuilder electronic module with:
an auxiliary unit connection to connect an auxiliary unit chosen amongst a plurality of different auxiliary units which can be installed on this truck, each auxiliary unit being able to drive an auxiliary equipment added to the truck after its construction, this auxiliary unit connection being able to transmit, to the auxiliary unit, information on the operating state of the truck which is built from data read on the bus,
a first non-volatile memory zone, content of which cannot be modified through the configuration connection, the first non-volatile memory zone storing a first predetermined list of authorized mathematical operators and a second predetermined list of a plurality of authorized operands, each operand corresponding to a data generated by one of the electronic control units or one of the sensors,
a second non-volatile memory zone, content of which can be modified through the configuration connection, the second non-volatile memory zone storing information defining a mathematical operation, the mathematical operation being formed by a combination of operators and operands,
a microprocessor able:
to execute the mathematical operation defined by the information stored in the second non-volatile memory zone only if each of the operators and operands of the defined mathematical operation matches an authorized operator or operand stored in the first non-volatile memory zone, and
to transmit the result of the executed mathematical operation to the auxiliary unit through the auxiliary unit connection,
displaying mathematical operators and operands in respective list zones, each list zone being populated only with the authorized mathematical operators and operands, respectively,
acquiring the operator and operand selected by an operator in the list zone to define a mathematical operation, and
downloading the defined mathematical operation into the second nonvolatile memory zone from a computer connected to the module through the configuration connection.

13. A memory including instructions to execute a method according to claim 12, to configure a bodybuilder electronic module of a truck when the instructions are executed by a computer.

14. A software including instructions to execute a method according to claim 12, to configure a bodybuilder electronic module of a truck when the instructions are executed by a computer.
